(19) United States
(12) Patent Application Publication
(10) Pub. No.: US 2004/0059557 A1
(43) Pub. Date: Mar. 25, 2004

(54) Flexible system simulation architecture, its interface and operating method

(75) Inventors: Cheng Shun Liao, Taipei (TW); Po Wen Chen, Taipei (TW)

Correspondence Address: BACON & THOMAS, PLLC, 625 SLATERS LANE, FOURTH FLOOR, ALEXANDRIA, VA, 22314

(73) Assignee: INSTITUTE FOR INFORMATION INDUSTRY, Taipei (TW)

(21) Appl. No.: 10/325,871

(22) Filed: Dec. 23, 2002

(30) Foreign Application Priority Data
Sep. 24, 2002 (TW) 91121923

(51) Int. Cl. G06F 17/50

(52) U.S. Cl. 703/13

(57) ABSTRACT

A flexible system simulation architecture, its interface and operating method are provided for simulating an electronic device. A rendering, a kernel, and application programs are separated from one another. An API (Application Program Interface) is disposed between an application program object and a system kernel object. A GSI (Generic Simulator Interface) is provided between the rendering object and the system kernel object. The rendering object not only performs simulations via a plurality of EPs (Entry Points) provided by application program object but also accesses library in the system kernel object via the GSI, and shows results performed by the application program object.

### BACKGROUND OF THE INVENTION

1. Field of the Invention

The present invention relates to a simulator and, more particularly, to a flexible system simulation architecture, its interface and operating method.

2. Description of Related Art

Conventionally, hardware design and software (e.g., application programs) development phases are required in developing an electronic device. In addition, it is typical to simulate the electronic device on a computer and display a rendering of the electronic device in the developing phases. A known simulator generally comprises a rendering, a kernel, and applications.

However, the prior art suffered from several disadvantages. For example, there is a high dependence between the rendering and the kernel of the simulator. As such, it is impossible to independently develop and test both. Alternatively, there is a high dependence between the rendering and the applications, resulting in a prohibition of substitution each other. Moreover, the well-known simulator may be customized according to a specific platform or operating system (OS). For example, Palm OS is widely used in personal digital assistants (PDAs). Further, the simulator is designed to simulate instruction sets of central processing unit (CPU). Hence, one of a variety of hardware platforms must have its distinct simulator. As a result, the well-known simulator is incapable of supporting all hardware platforms.

Therefore, it is desirable for the above conventional simulator to be improved so as to mitigate and/or obviate the aforementioned problems.

### SUMMARY OF THE INVENTION

The first object of the present invention is to provide a flexible system simulation structure, its interface and operating method, so that manufactures can reduce the time to develop simulator for their products.

The second object of the present invention is to provide a flexible system simulation structure, its interface and operating method, so that manufactures can make different simulators by changing rendering for series of products.

The third object of the present invention is to provide a flexible system simulation structure, its interface and operating method, so that manufactures can install different kernel of embedded system in the same target machine and provide different simulators by changing kernel.

The forth object of the present invention is to provide a flexible system simulation structure, its interface and operating method, so that manufactures do not need to re-construct all components of the simulator thereby saving a lot of time.

In one aspect of the present invention, there is provided a flexible system simulation architecture for simulating an electronic device, which comprises an application program object including a plurality of sets of application program codes; a rendering object for showing results of a plurality of simulations obtained by performing the sets of application program codes; and a system kernel object for providing a library for the application program object and the rendering object.

In another aspect of the present invention, there is provided a system simulation interface for use with an application program object including a plurality of sets of application program codes, a rendering object, and a system kernel object. The system simulation interface comprises an application program interface (API) between the application program object and the system kernel object for enabling the application program object to access a library provided by the system kernel object via the API; a plurality of entry points (EPs) provided by the sets of application program codes so that the rendering object is capable of performing a plurality of simulations provided by the sets of application program codes via the EPs; and a generic simulator interface (GSI) between the rendering object and the system kernel object, the GSI including at least one driver interface so that the rendering object is capable of showing results of the simulations by means of the driver interface and the system kernel object.

In still another aspect of the present invention, there is provided an operating method of flexible system simulator for use with an application program object including a plurality of sets of application program codes, a rendering object, and a system kernel object, the method comprising the steps of: (A) performing the rendering object; (B) loading the system kernel object prior to coupling the rendering object and the system kernel object together; (C) loading the application program object prior to obtaining a plurality of entry points (EPs) from the application program object corresponding to a plurality of sets of application program codes; and (D) initializing a system configuration for performing the application program object on the rendering object and testing/debugging the sets of application program codes.

Other objects, advantages, and novel features of the invention will become more apparent from the detailed description when taken in conjunction with the accompanying drawings.

### BRIEF DESCRIPTION OF THE DRAWINGS

FIG. 1 is a block diagram of the invention;

FIG. 2 is a top plan view of the rendering of the simulator in accordance with the invention;

FIG. 3 schematically depicts the system kernel in accordance with the invention;

FIG. 4 shows a set of application program codes according to the invention; and

FIG. 5 is flow chart illustrating a process performed by the simulator of the invention.

### DETAILED DESCRIPTION OF THE PREFERRED EMBODIMENT

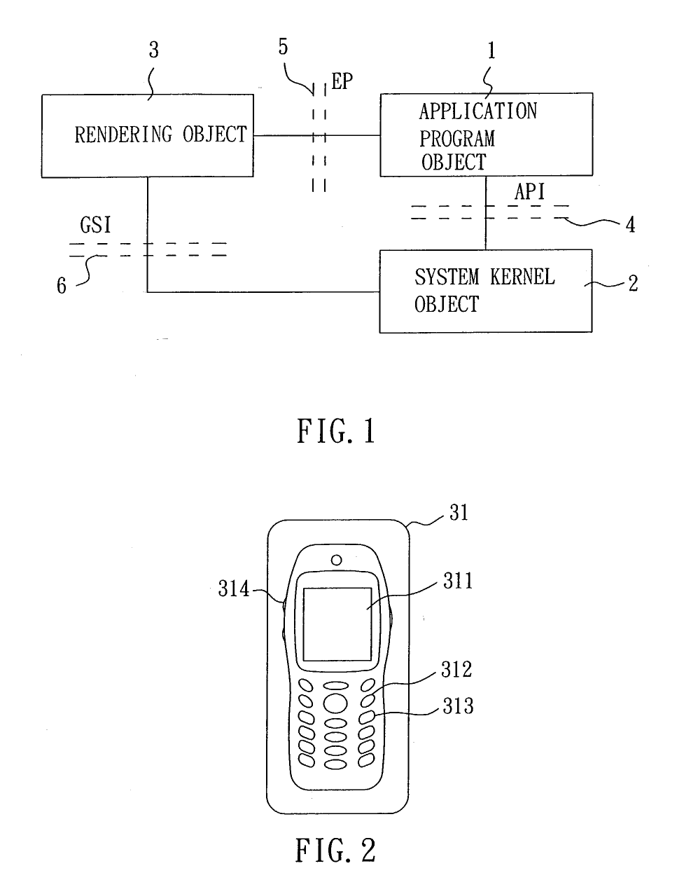

With reference to FIG. 1, there is shown a block diagram in accordance with the invention. The invention comprises an application program object 1, a system kernel object (e.g., embedded system kernel object) 2, and an rendering object 3. The application program object 1 comprises a plurality of sets of application program codes, each having an EP (Entry Point) 5. The rendering object 3 can perform at least one simulation provided by the sets of application program codes.

An API (Application Program Interface) 4 is disposed between the application program object 1 and the system kernel object 2. Thus, the application program object 1 can access at least one library provided by the system kernel object 2 via the API 4. A GSI (Generic Simulator Interface) 6 is provided between the rendering object 3 and the system kernel object 2. The GSI 6 provides at least one basic hardware driver interface (e.g., LCD, Touch Panel, Key Pad and so on) so that the rendering object 3 can perform a plurality of simulations provided by the sets of application program codes via the GSI 6 and accessing the library of the system kernel object 2. Alternatively, the system kernel object 2 can display the result via the GSI 6.

With reference to FIG. 2, there is shown a top plan view of the rendering object 3. The rendering object 3 is schematically represented as a rendering picture 31 for showing its appearance, instructions, and messages. The rendering picture 31 can be implemented in one of a variety of electronic devices for simulation. For example, a cellular phone is shown in the rendering picture 31. The cellular phone comprises a display 311 for simulating a typical LCD (liquid crystal display) or touch panel, a function keypad 312, a numeric keypad 313, and a hot key unit 314 for simulating up/down scrolling or pagedown/pageup. It is appreciated that the rendering picture 31 may be shown as any other device (e.g., PDA or the like) depending on the electronic device to be simulated.

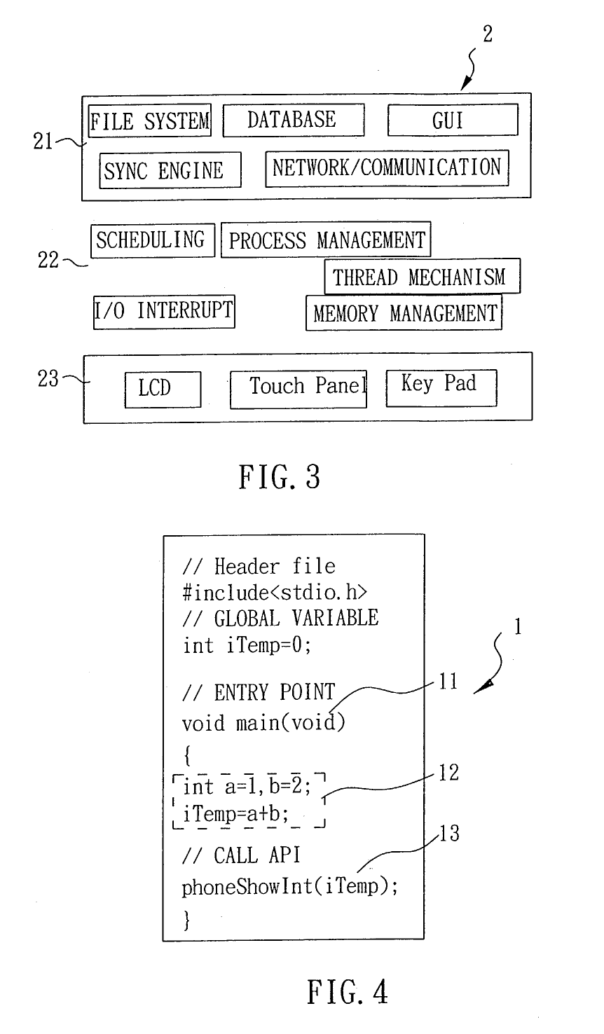

With reference to FIG. 3, it schematically depicts constituent components of the system kernel object 2. The system kernel object 2 comprises three major libraries: a middleware layer 21, a kernel layer 22, and a driver layer 23. The middleware layer 21 is used to provide the enhanced functions for the application program object 1. The middleware layer 21 includes file system, database, graphic user interface (GUI), sync engine, network/communication and other libraries that can be used by the application program object 1. The kernel layer 22 provides the basic operating system functions such as scheduling, process management, thread mechanism, I/O interrupt, memory management and so on. The driver layer 23 is used to provide the interfaces to access the hardware. In the target machine, the driver is used to drive the hardware. In the simulator, the driver is combined with the rendering object 3 through the GSI 6. The APIs in the middleware layer 21, the kernel layer 22 and the driver layer 23 compose the API 4.

With reference to FIG. 4, there is shown a set of application program codes contained in the application program object 1. There are shown an EP 11 (e.g., void main(void)), a variable setting portion 12, and a call application program interface (API) 13 (e.g., phoneShowInt(iTemp)). It is appreciated that the EP 11, the variable setting portion 12, and the call API 13 may be shown differently if the set of application program codes are written in a programming language other than the above. The application program object 1 can be written in C, C++, JAVA, Visual Basic and so on.

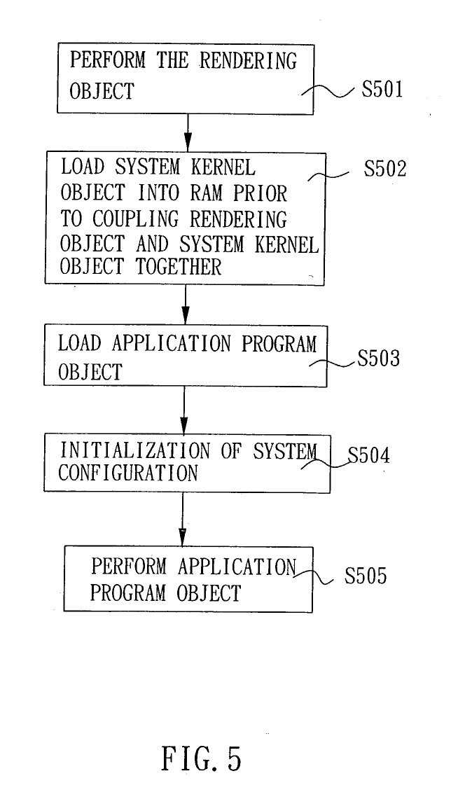

With reference to FIG. 5 in conjunction with FIG. 1, there is shown a flow chart illustrating a process performed by simulator of the invention. In step S501, a developer first performs the rendering object 3 (i.e., programs) when simulating an application program being developed on an electronic device. In step S502, the system kernel object 2 is loaded into a memory (e.g., RAM (Random Access Memory)) prior to coupling the hardware functionalities simulated by the rendering object 3 and the system kernel object 2 together. As a result, the hardware functionalities to be used by the system kernel object 2 can be simulated. In step S503, the application program object 1 is loaded. It comprises two sub-steps: first, loading the application program object 1 into RAM and then obtaining EPs from the application program object 1 corresponding to a plurality of sets of application program codes. In step S504, an initialization of system configuration is performed. In step S505, the application program object 1 is performed on the rendering object 3 and the sets of application program codes are tested/debugged. Further, results obtained by performing the sets of application program codes are associated with an UI (user interface) and are shown on the rendering object 3.

Although the present invention has been explained in relation to its preferred embodiment, it is to be understood that many other possible modifications and variations can be made without departing from the spirit and scope of the invention as hereinafter claimed.

What is claimed is:

1. A flexible system simulation architecture for simulating an electronic device comprising:
an application program object including a plurality of sets of application program codes;
a rendering object for showing results of a plurality of simulations obtained by performing the sets of application program codes; and
a system kernel object for providing a library for the application program object and the rendering object.

2. The system simulation architecture as claimed in claim 1, further comprising an application program interface (API) between the application program object and the system kernel object, so that the application program object is capable of accessing the library via the API.

3. The system simulation architecture as claimed in claim 1, wherein each of the sets of application program codes has an entry point (EP), so that the rendering object can perform a plurality of simulations provided by the sets of application program codes.

4. The system simulation architecture as claimed in claim 1, further comprising a generic simulator interface (GSI) between the rendering object and the system kernel object, so that the rendering object and the system kernel object are capable of updating independently.

5. The system simulation architecture as claimed in claim 1, wherein the system kernel object is an embedded system kernel object.

6. The system simulation architecture as claimed in claim 1, wherein the rendering object is operative to simulate a keypad, a scrolling, and a display of the electronic device.

7. The system simulation architecture as claimed in claim 1, wherein the results of the simulations comprise an appearance, instructions, and messages.

8. A system simulation interface for use with an application program object including a plurality of sets of application program codes, an rendering object, and a system kernel object, the system simulation interface comprising:
an application program interface (API) between the application program object and the system kernel object for enabling the application program object to access a library provided by the system kernel object via the API;
a plurality of entry points (EPs) provided by the sets of application program codes so that the rendering object is capable of performing a plurality of simulations provided by the sets of application program codes via the EPs; and
a generic simulator interface (GSI) between the rendering object and the system kernel object, the GSI including at least one driver interface so that the rendering object is capable of showing results of the simulations by means of the driver interface and the system kernel object.

9. The system simulation interface as claimed in claim 8, wherein the system kernel object is operative to independently update both the rendering object and the system kernel object.

10. An operating method of flexible system simulator for use with an application program object including a plurality of sets of application program codes, a rendering object, and a system kernel object, the method comprising the steps of:
(A) performing the rendering object;
(B) loading the system kernel object prior to coupling the rendering object and the system kernel object together;
(C) loading the application program object prior to obtaining a plurality of entry points (EPs) from the application program object corresponding to a plurality of sets of application program codes; and
(D) initializing a system configuration for performing the application program object on the rendering object and testing/debugging the sets of application program codes.

11. The method as claimed in claim 10, wherein results obtained by performing the sets of application program codes are associated with a user interface (UI) and are shown on the rendering object.

12. The method as claimed in claim 10, wherein both the application program object and the system kernel object are loaded into a storage means.

13. The method as claimed in claim 12, wherein the storage means is a random access memory (RAM).

14. The method as claimed in claim 10, wherein the rendering object is operative to simulate hardware functionalities of the application program object.
